(19) United States
(12) Patent Application Publication
(10) Pub. No.: US 2025/0188906 A1
(43) Pub. Date: Jun. 12, 2025

(54) WIND HARNESS FOR A VEHICLE

(71) Applicant: FCA US LLC, Auburn Hills, MI (US)

(72) Inventor: Azard Mohammed Shaik, Troy, MI (US)

(21) Appl. No.: 18/536,747

(22) Filed: Dec. 12, 2023

(51) Int. Cl. F03D 9/32; B60R 16/03; F03D 1/04; H02K 7/18

(52) U.S. Cl. CPC F03D 9/32; B60R 16/03; F03D 1/04; H02K 7/183; F05B 2240/941

(57) ABSTRACT

A wind harness for a vehicle includes a plurality of troughs positioned substantially parallel to one another. A plurality of opening in each trough formed at a bottom of the troughs so that the trough openings received airflow. The airflow is directed to the plurality of openings. A plurality of turbines, at least one turbine positioned adjacent each opening for receiving airflow directed from the openings. The plurality of turbines is activated by the air flow for generating electric for the vehicle.

### FIELD

The present disclosure relates to vehicles and, more particularly, to a wind harness utilizing wind to produce electrical energy.

### BACKGROUND

This section provides background information related to the present disclosure which is not necessarily prior art.

In automotive vehicles, when they are moving, they are constantly exposed to a wind force. Ordinarily, as the vehicle speed increases, the force of the wind on and around the vehicle increases. Thus, there is wind present at a significant speed on the vehicle. Thus, it would be desirable to utilize the wind speed and force to generate electricity via a wind turbine. Several different types of electrical generation devices have been provided in the art. However, these devices have drawbacks when applying them to the vehicle to generate electricity.

Thus, it would be desirable to utilize the wind force hitting the vehicle and harnessing the wind to generate electricity. Accordingly, the present disclosure provides a wind harnessing device.

The present device provides a wind harness having a plurality of troughs in the front grille of the vehicle. The harness may include openings in each trough to enable the airflow to flow into the harness. The harness delivers air flow to mini-turbines associated with each opening, when the car is moving, so that the air flows through the harness and generates electricity via the wind turbines.

### SUMMARY

This section provides a general summary of the disclosure, and is not a comprehensive disclosure of its full scope or all of its features.

According to a first aspect of the disclosure, a wind harness for a vehicle comprises a plurality of troughs positioned substantially parallel to one another. A plurality of openings in each trough are formed at a bottom of the trough so that as the troughs receive airflow, the airflow is directed into the plurality of openings. A plurality of turbines, at least one turbine is positioned at each opening to receive the airflow directed from the openings. The plurality of turbines are activated by the air flow to generate electricity for the vehicle. A plurality of ducts, with each duct including an end, coupled with the through opening. At least one turbine is positioned adjacent the duct opening. The troughs include at least four openings. Preferably there are six troughs in a group. The plurality of troughs is positioned on a vehicle grille. The plurality of turbines are mini air turbines.

According to a second aspect of the disclosure, a vehicle with a wind harness comprises a front grille on a body of the vehicle. A plurality of troughs is positioned parallel to one another in the grille. A plurality of openings is in each trough form at a bottom of the trough so that as the troughs receive airflow, the airflow is directed into the plurality of openings. A plurality of turbines, with at least one turbine positioned adjacent each opening to receive airflow directed from the openings. The plurality of turbines are activated by the air flow to generate electricity for the vehicle. A plurality of ducts, each duct having an end, is coupled with the through opening. At least one turbine is positioned adjacent the duct. The troughs include at least four openings. Preferably there are six troughs. The plurality of turbines are mini air turbines.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a vehicle including a wind harness.

FIG. 2 is an enlarged elevation view of the wind harness.

FIG. 3 is a side elevation view of the wind harness.

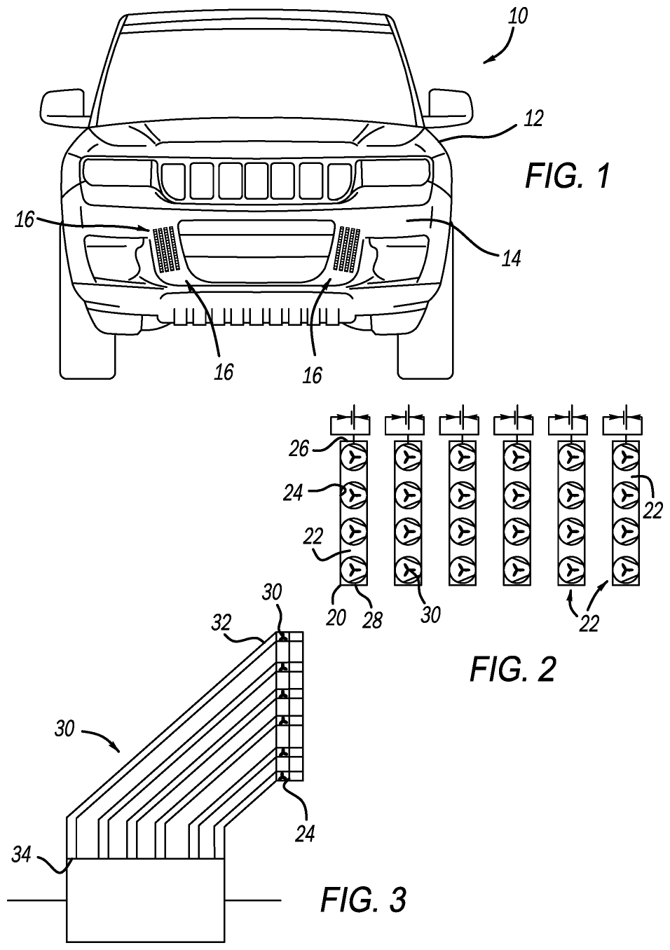

Corresponding reference numerals indicate corresponding parts throughout the several views of the drawings.

### DETAILED DESCRIPTION

Example embodiments will now be described more fully with reference to the accompanying drawings.

Turning to figures, a vehicle is illustrated and designated with the reference numeral 10. The vehicle 10 includes a body 12 with a front grille 14. The grille 14 includes a wind harness 16 positioned in the grille 14.

The wind harness 16 includes a plurality of troughs 20. The troughs 20 may be a severed pipe including a concave surface 22 with a plurality of openings 24 on the bottom of the concave surface 22. Also, the troughs generally include terminal ends 26 and 28 that prohibit wind from escaping axially along the troughs 20. The troughs 20 are illustrated vertically extending on the vehicle grille 14; however, they could be horizontally positioned or angularly positioned on the grille 14.

Each opening 24 receives a turbine 30. The turbines 30 are mini wind turbines and are positioned adjacent the exit of the openings 24. The troughs 20 may include an opening conduit 32 that houses the turbine 30. The conduit 32 may be shaped to provide a nozzling effect to direct the airflow towards the turbines 30. The duct 32 may extend through the vehicle 10 so that the air flow exits the vehicle below the vehicle. The ducts 32 have a first end that is connected at the opening and a second end 34 to enable the exhaust to exit to ambient. Thus, the airflow is received by the troughs 20 funneled into the openings 24 pass the turbines 30 and exits underneath the vehicle 10.

Additionally, one or more mini turbines 30 could be positioned in the conduit 32, one behind the other. Also, the troughs 20 may have V shape or U shape or truncated V-shape with the openings at the web or connection of the surfaces. The surfaces direct the airflow contacting the front of the vehicle 10 through the openings 24 to the mini wind turbines 30 which, in turn, generate electricity for the vehicle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A wind harness for a vehicle comprising:
a plurality of troughs positioned substantially parallel to one another;
a plurality of opening in each trough formed at a bottom of the troughs so that the troughs funnel air flow into the openings so that the airflow is directed by the troughs into the plurality of openings;
a plurality of turbines, at least one turbine positioned adjacent each opening for receiving airflow directed from the trough into the openings, the plurality of turbines is activated by the air flow for generating electricity for the vehicle.

2. The wind harness for a vehicle of claim 1, further comprising a plurality of ducts, each duct having an end coupled with the trough openings.

3. The wind harness for a vehicle of claim 2, wherein the at least one turbine is positioned in the duct.

4. The wind harness for a vehicle of claim 1, wherein the trough includes four openings.

5. The wind harness for a vehicle of claim 1, wherein there are six troughs.

6. The wind harness for a vehicle of claim 1, wherein the plurality of troughs is positioned on a vehicle grille.

7. The wind harness for a vehicle of claim 1, wherein the plurality of turbines are mini air turbines.

8. A vehicle with a wind harness comprising:
a front grille of a body of the vehicle;
a plurality of troughs positioned substantially parallel to one another on the front grille;
a plurality of opening in each trough formed at a bottom of the troughs so that the troughs funnel air flow into the openings so that the airflow is directed by the troughs into the plurality of openings;
a plurality of turbines, at least one turbine positioned adjacent each opening for receiving airflow directed from the trough into the openings, the plurality of turbines is activated by the air flow for generating electricity for the vehicle.

9. The vehicle with a wind harness of claim 8, further comprising a plurality of ducts, each duct having an end coupled with the trough openings.

10. The vehicle with a wind harness of claim 9, wherein the at least one turbine is positioned in the duct.

11. The vehicle with a wind harness of claim 8, wherein the trough includes four openings.

12. The vehicle with a wind harness of claim 8, wherein there are six troughs.

13. The vehicle with a wind harness of claim 8, wherein the plurality of troughs is positioned on a vehicle grille.

14. The vehicle with a wind harness of claim 8, wherein the plurality of turbines are mini air turbines.
